(19) United States
(12) Patent Application Publication
(10) Pub. No.: US 2008/0228396 A1
(43) Pub. Date: Sep. 18, 2008

(54) SYSTEM AND METHOD FOR UPDATING A STATISTICAL DATABASE IN A VEHICLE NAVIGATION SYSTEM

(75) Inventors: Kimiyoshi Machii, Novi, MI (US); Sadanori Horiguchi, Novi, MI (US)

Correspondence Address: GIFFORD, KRASS, SPRINKLE,ANDERSON & CITKOWSKI, P.C, PO BOX 7021, TROY, MI, 48007-7021, US

(73) Assignee: Xanavi Informatics Corporation, Kanagawa-Ken (JP)

(21) Appl. No.: 11/687,178

(22) Filed: Mar. 16, 2007

(51) Int. Cl. G01C 21/32

(52) U.S. Cl. 701/209; 455/3.01

(57) ABSTRACT

In a navigation system of a vehicle having a statistical database containing travel information for a plurality of road links, a method and system for updating data contained in the statistical database. Real-time travel data for the vehicle is acquired for at least one of the road links in the statistical database as the vehicle travels between the end nodes of that road link. The acquired real-time travel data is then processed to ensure that it meets certain criteria, e.g. the absence of nonrepeating incidents. Travel data which meets that criteria is then utilized to update the road link data in the statistical database. The travel data acquisition, processing and updating of the statistical database is performed internally in the navigation system without interconnecting to external servers.

### BACKGROUND OF THE INVENTION

I. Field of the Invention

The present invention relates generally to a method and system for updating a statistical database contained in a motor vehicle navigation system.

II. Description of Related Art

Navigation systems of the type used in automotive motor vehicles have enjoyed increased popularity. Such navigation systems are particularly useful for providing routing instructions on a display screen to the operator of the motor vehicle.

These previously known navigation systems typically contain a map database which includes map data for route calculations by the navigation system. The map database includes mesh data including road link data as well as node data.

The navigation system also includes a statistical traffic database which contains information relating to the travel time for the various road links in the map database. The data in the statistical database is utilized by the navigation system to estimate the travel times during route calculations as well as to calculate a preferred route from the position of the vehicle and to an inputted destination location.

In one system, the statistical traffic data is initially installed in the statistical traffic database upon installation of the navigation system. Thereafter, the system updates the statistical traffic database from data received through data servers.

One disadvantage of these previously known systems, however, is that it is necessary for the system to connect to a data server in order to receive the traffic data. This, in turn, disadvantageously forces the operators of the motor vehicles to likely incur communication fees and increased bandwidth requirements which may slow communication whenever the server is accessed. Furthermore, data through servers may not be able to be received due to lack of coverage.

### SUMMARY OF THE PRESENT INVENTION

The present invention provides a system for updating the statistical database in a vehicle navigation system that overcomes the above-mentioned disadvantages of the previously known navigation systems.

In brief, the navigation system of the present invention includes a statistical database containing travel information for a plurality of road links, each of them having two end nodes. Ideally, the statistical database contains information relating to the expected travel time of the various road links based on historical information.

During operation of the vehicle, the navigation system acquires real-time travel data for the road links as the vehicle travels from one end node to the other end node of the road links. That real-time data is then processed internally by the navigation system to ensure that the real-time data meets preset criteria for the particular road link. If so, the navigation system then internally updates the road link data in the statistical database to reflect the acquired real-time travel data of the vehicle.

Various types of different processing may be utilized to ensure that the real-time travel data of the vehicle accurately reflects the travel time for the road link during normal driving conditions. For example, in the event of an incident, such as an automotive accident, on the road link, the travel time for that particular road link is typically greatly increased so that the actual real-time travel data of the vehicle on that road link containing an incident is statistically nonrepeatable and does not accurately reflect the travel time for that road link.

In order to detect such nonrepeatable incidents, the method of the present invention compares the real-time travel data from the vehicle on the road link with the previously stored travel time in the statistical database. In the event that the real-time travel data for the vehicle on that particular road link differs from the previously stored data in the statistical database by more than a predetermined amount, indicative of a nonrepeatable incident, the real-time travel data is simply disregarded. Otherwise, the real-time travel data is utilized to update the road link data in the statistical database.

Other processing of the real-time travel data of the vehicle may also be performed in order to provide more accurate data in the statistical database. For example, in order to compensate for real-time traffic flow fluctuations, preferably a plurality of data samples of the real-time travel data for each road link are accumulated and an average value is determined. That average value is then utilized to update the statistical database. For example, a predetermined number of samples, for example five samples of test data, may be required by the navigation system for a particular road link before updating the road link information in the statistical database.

In order to achieve accurate data within the statistical database, the statistical database optionally includes a weather code for each of the various road links. These weather codes can include, for example, a code pertaining to rain, snow, fog, etc. The navigation system then receives weather data, typically from radio broadcasts, indicative of the weather and stores that weather condition together with the travel data to ensure proper updating of the statistical database.

Optionally, a driver code identifying different drivers of the vehicle may also be associated with each road link in the statistical database. Such additional driver codes would reflect the different driving habits of different drivers along the various road links. Still other codes, such as a season code, construction code, etc. may also be associated with each road link.

### BRIEF DESCRIPTION OF THE DRAWING

A better understanding of the present invention will be bad upon reference to the following detailed description when read in conjunction with the accompanying drawing, wherein like reference characters refer to like parts throughout the several views, and in which:

FIG. 1 is a block diagrammatic view illustrating the system configuration for the navigation system of the present invention;

FIG. 2 is a block diagrammatic view illustrating the software configuration for the navigation system of the present invention;

FIG. 3 is an exemplary database configuration of the statistical database;

FIG. 4 is a database configuration of the vehicle tracking database;

FIG. 5 is a database configuration for the link travel time database;

FIG. 6 is an overall process view of traffic data update of the present invention;

FIG. 7 is a flowchart illustrating the tracking data accumulation;

FIG. 8 is a flowchart illustrating one form of statistical processing;

FIG. 9 is an exemplary weather code definition;

FIG. 10 is exemplary code definitions for season code, driver, and/or construction code;

FIG. 11 is a view similar to FIG. 8 but illustrating a modification thereof; and

FIG. 12 is a flowchart illustrating the acquisition and processing of data containing road incidents.

### DETAILED DESCRIPTION OF PREFERRED EMBODIMENTS OF THE PRESENT INVENTION

With reference first to FIG. 1, a block diagrammatic view of a motor vehicle navigation system 20 according to the present invention is illustrated. The navigation system 20 includes a processor 22 which receives various inputs indicative of the location and speed of the vehicle. Specifically, the processor 22 receives an input from a global positioning system (GPS) circuit 24. In the well-known fashion, the GPS circuit 24 receives signals from GPS satellites 26 indicative of the current position of the motor vehicle. The GPS circuit 24 then provides this information as data to the processor 22.

A gyro compass 26 in the navigation system 20 produces a signal on its output representative of the current direction of travel of the motor vehicle. The gyro compass 26 provides this information as an input signal to the processor 22.

A vehicle speed sensor 28 also provides an output signal to the processor 22 representative of the speed of the motor vehicle. Consequently, the position of the motor vehicle may be determined by “dead reckoning” from the outputs of the gyro compass 26 and motor speed sensor 28 if the signal from the GPS 24 is unavailable.

Optionally, a radio data receiver 30 in a navigation system 20 receives data from one or more radio stations 32. Such radio stations 32, which may be either satellite radio or land-based radio, provide, inter alia, traffic data and weather data. The radio receiver 30 receives this data and provides the data to the processor 22.

The processor 22 is also connected to a persistent storage device 32, such as a hard drive, which stores data in the well-known manner. Likewise, the processor 22 has access to digital random access memory 32 as well as a screen display 34 that is visible to the operator of the vehicle. Typically, the processor 22 utilizes the display screen 34 to display map and route information as well as other types of information.

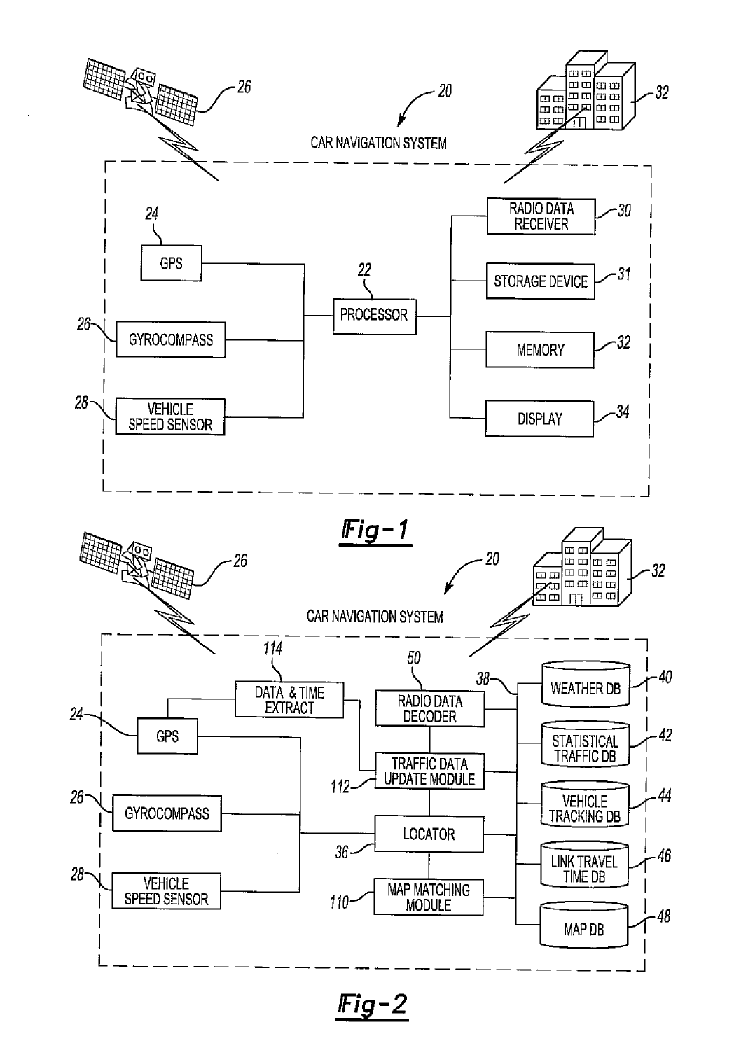

With reference now to FIG. 2, an exemplary software configuration is shown for use with the navigation system 20 of the present invention illustrated in FIG. 1. The software configuration includes a locator module 36 programmed to receive the inputs from the vehicle speed sensor 28, gyro compass 26 and GPS circuit 24 to locate the current position of the motor vehicle. If the position of the vehicle as determined by dead reckoning, i.e. from the outputs of the gyro compass 26 and vehicle speed sensor 28, is far from the location of the vehicle as determined from the GPS circuit 24, the locator module 36 adopts the current position of the vehicle to the position as determined from the GPS circuit 24.

The locator module 36 is also connected through a bus 38 to a plurality of databases. These databases include a weather database 40, a statistical traffic database 42, a vehicle tracking database 44, a link travel time database 46, and a map database 48. All of these databases 40-48 are contained in the storage device 31 (FIG. 1) or memory 32 and each database 40-48 serves a different purpose. Furthermore, although the databases 40-48 are illustrated in FIG. 2 as separate databases, they may be combined or further subdivided.

More specifically, the weather database 40 receives and stores weather data from a radio data decoder 50 from the transmissions from the radio station 32. Such weather data may be received from a dedicated weather data transmission or part of a transmission of general road link data. Consequently, the data in the weather database 40 frequently changes in accordance with current weather conditions.

The statistical database 42 includes statistically processed traffic data of the travel time to travel the various road links. The data contained in the statistical traffic database 42 is typically initialized upon installation of the navigation system based upon real-time historical data, calculated road link travel times, etc.

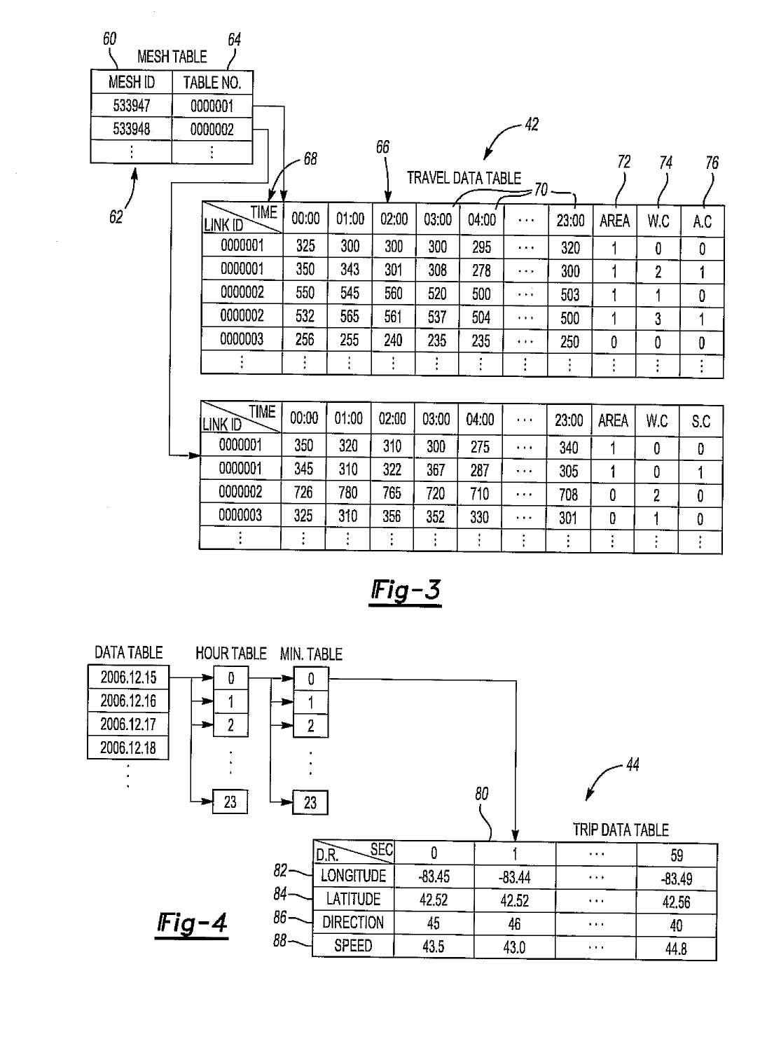

With reference now to FIG. 3, an exemplary configuration for the statistical traffic database 42 is shown. The database 42 includes a mesh table 60 having a mesh ID field 62. The mesh ID field 62 corresponds to different grids on the map and each mesh ID is associated with a table number 64, each of which points to a different traffic data table 66.

Each traffic data table 66 includes a road link ID field 68 and a plurality of data entries 70 are associated with each road link. These different data fields contain information for the traffic travel time or average speed at different times of the day.

Preferably, an area flag 72, weather code 74 and auxiliary code 76, such as a construction code, season code, etc. is associated for each road link. Furthermore, each entry in the traffic data table 66 for each road link is preferably unique so that multiple entries for a single road link may be contained within the traffic data table for different area flags 72, weather codes 74 and different auxiliary codes 76.

With reference again to FIG. 2, the vehicle tracking database 44 includes tracking data of the vehicle by its position, i.e. latitude and longitude, as well as the speed and direction of the vehicle. An exemplary database structure for the vehicle tracking database is shown in FIG. 4 in which the vehicle tracking database 44 includes a trip data table 80 having data fields for longitude 82, latitude 84, vehicle direction 86 and vehicle speed 88. These data fields, furthermore, are preferably maintained for each sequential second of operation of the vehicle on the trip and may be deleted to conserve memory when no longer useful.

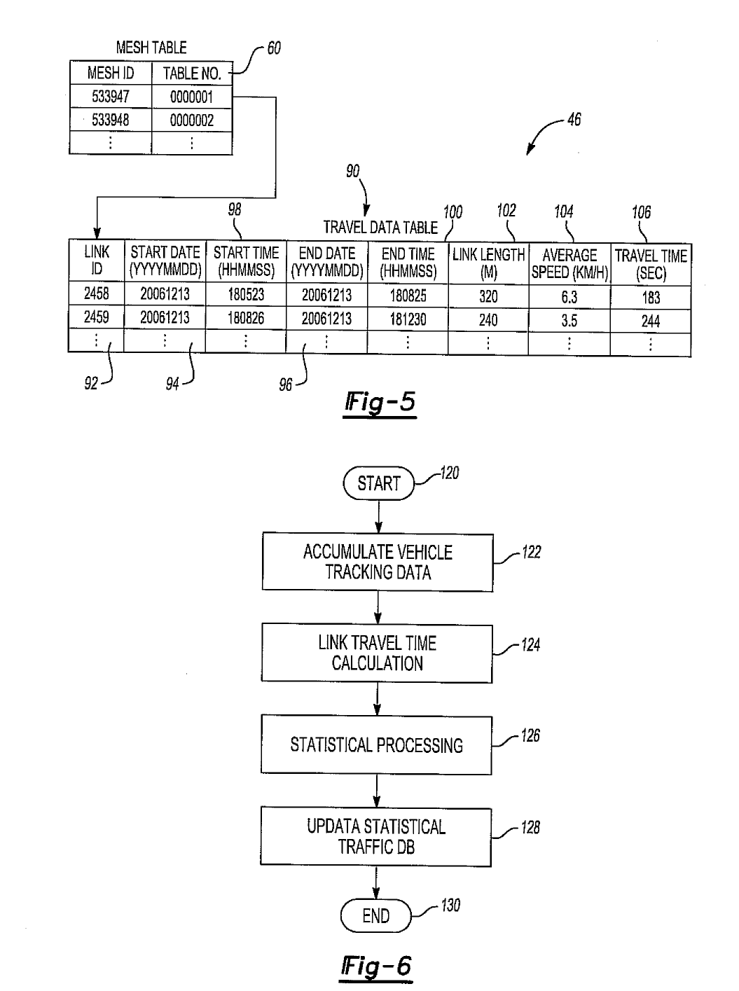

With reference again to FIG. 3, the link travel time database 46 includes data for each road link traveled by the vehicle. An exemplary link travel database 46 is illustrated in FIG. 5 and includes the mesh table 60 (see FIG. 3). The link travel time database 46 also includes a travel data table 90.

The travel database 90 has a field 92 corresponding to the link ID of the road links actually traveled by the vehicle. Each road link, includes a starting and ending date stamp in fields 94 and 96, respectively, as well as a start time and end time in fields 98 and 100, respectively. The length of the road link is also contained in a field 102 as well as the average speed in field 104 and travel time in field 106.

Referring again to FIG. 2, the map database 48 includes map data for route calculations. The map data includes mesh data contained in mesh table 60 as well as road link data and node data.

Still referring to FIG. 2, the software configuration also includes a map matching module 110. The map matching module 110 receives the information from the locator module 36 indicative of the position of the car and then matches that position to a road link contained in the map database 48. The software configuration also includes a traffic data update module 112 which not only updates the vehicle tracking database and link travel time database, but also updates the statistical traffic database 42 in a fashion to be subsequently described. This traffic data update module 112 also receives time and date information from the GPS module 24 through a date and time extract module 114.

In a fashion that will be subsequently described in greater detail, the processor 22 in the navigation system 20 (FIG. 1) internally updates the statistical travel database 42 (FIG. 2) based on real-time travel of the vehicle along various road segments. With reference then to FIG. 6, an overview of the algorithm used to update the statistical traffic database 42 is illustrated.

After initiation of the algorithm at step 120, step 120 proceeds to step 122. At step 122, the navigation system 20 accumulates or receives vehicle tracking data, i.e. data representing the travel time of the vehicle along at least one and more typically many road links. In the event that an incident has occurred on the particular road link traveled by the vehicle, The real-time travel data of the vehicle for that road link is inherently statistically irrelevant and should be disregarded. Such incidents include, for example, traffic accidents, road closures and the like. Furthermore, such traffic incidents are transmitted by the radio station 32 (FIG. 2) and received by the navigation system.

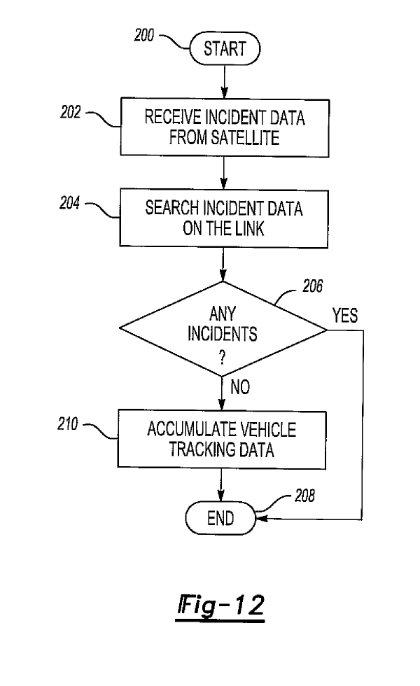

With reference then to FIG. 12, the processor determines whether the real-time vehicle tracking data acquired at step 122 should be disregarded as containing an incident. After initiation of the algorithm at step 200, step 200 proceeds to step 202 where the navigation system receives the traffic road link incident from the radio station 32. Step 202 then proceeds to step 204.

The incident data received at step 202 is then searched at step 204 and then proceeds to step 206 to determine whether or not an incident has occurred on the current vehicle road link. If so, step 206 proceeds to step 208 and exits from the routine without further processing of the real-time vehicle tracking data. Otherwise, step 206 proceeds to step 210 and accumulates the real-time vehicle road link data and then proceeds to step 124 (FIG. 6).

At step 124 the link travel time database 46 is updated as illustrated in the link travel time database structure (FIG. 5). Step 124 then proceeds to step 126.

At step 126, the processor 22 performs statistical processing on the accumulated data in a fashion subsequently described in greater detail. Step 126 then proceeds to step 128 where the processor 22 updates the statistical database 42 and then proceeds to step 130 which terminates the algorithm.

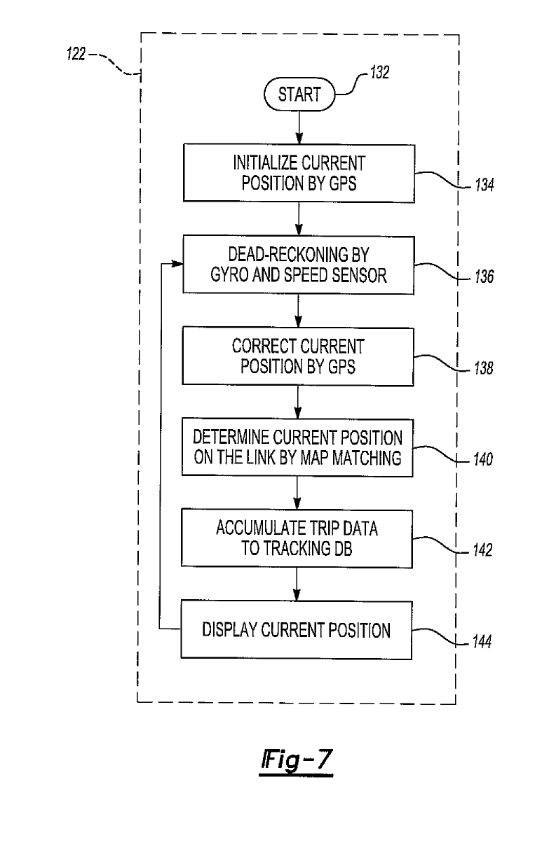

With reference now to FIGS. 6 and 7, the step 122 of accumulating the vehicle tracking data is illustrated in more detail in FIG. 7. After initiation at step 132, step 132 proceeds to step 134 where the current position of the vehicle is initialized by the processor 22 utilizing the output from the GPS module 24. Step 134 then proceeds to step 136.

At step 136, the processor 22 determines the position of the vehicle by dead reckoning utilizing the output signals from both the gyro compass 26 and vehicle speed sensor 28. Step 136 then proceeds to step 138.

At step 138, the processor 22 compares the vehicle position determined by dead reckoning with the current position as determined by the GPS system. If the difference between the position determined by dead reckoning varies from the position determined by GPS more than a predetermined amount, the position of the vehicle as determined by GPS is utilized as the vehicle location. Step 138 then proceeds to step 140.

At step 140 the processor 22 determines the current road link of the vehicle by matching the position of the vehicle as determined at step 138 with the data in the map database 48. Step 140 then proceeds to step 142.

At step 142, the processor 22 stores the tracking information in the tracking database (FIG. 5). Step 142 then proceeds to step 144 where the vehicle position is displayed on the display 34 (FIG. 1). Step 144 then branches back to step 136 where the above process is repeated at least until the end of the current road link.

From the foregoing, it can be seen that step 122 accumulates the real-time vehicle tracking data as the vehicle travels along at least one and typically several road links. The data is accumulated and stored by the processor in the link travel time database 46.

With again reference to FIG. 6, after the vehicle tracking data is accumulated at step 122, step 122 proceeds to step 124 where the various link travel time calculations are performed. These calculations include, for example, a calculation of the vehicle speed from one end and to the other end of the current road link as a function of the length of the road link stored in the map database 48 and the elapsed time of the vehicle from one end and to the other end of that road link. That calculation is stored in the average speed field 104 of the link travel time database (FIG. 5). Step 124 then proceeds to step 126.

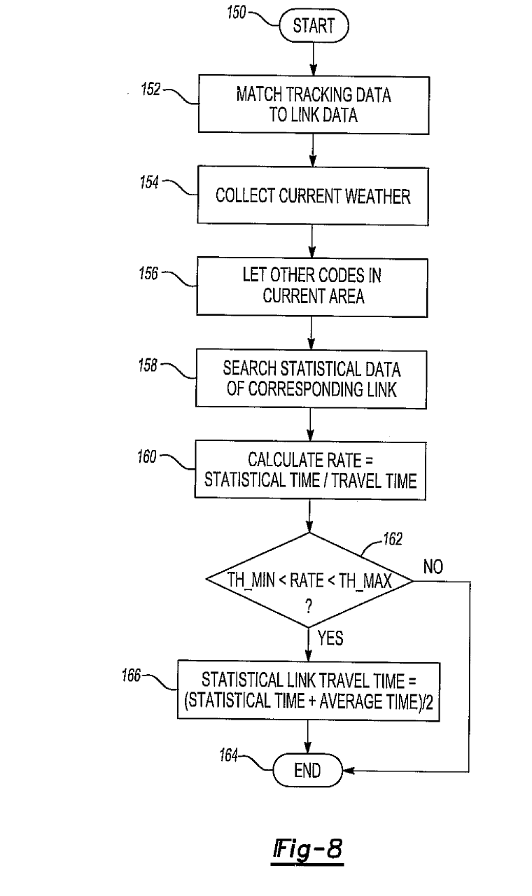

Step 126 subjects the accumulated vehicle tracking data to statistical processing which determines if the accumulated vehicle tracking data meets preset criteria before that data is used to update the statistical database 42. A flowchart illustrating one form of statistical processing is shown in FIG. 8.

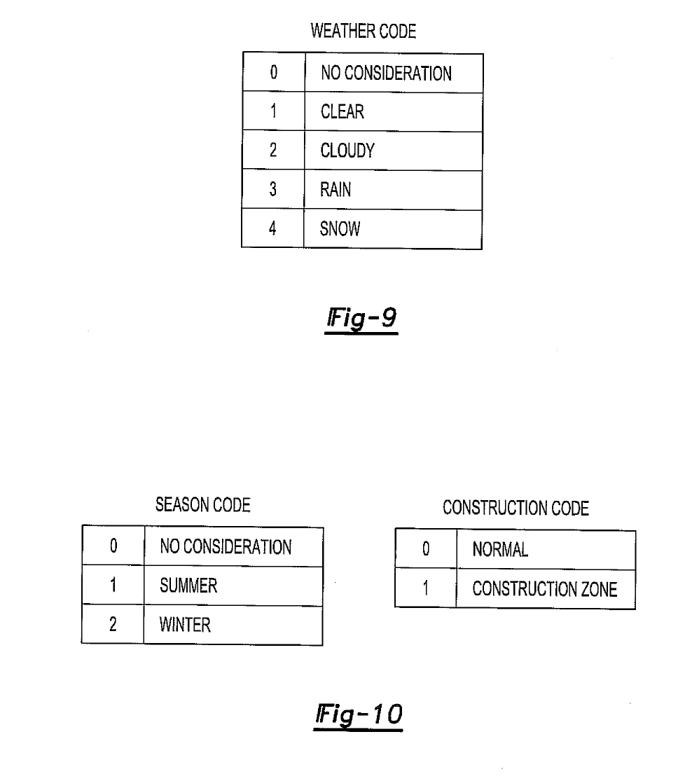

With reference then to FIG. 8, after initiation of the statistical processing algorithm at step 150, step 150 proceeds to step 152. At step 152 the processor matches the acquired tracking data to the link data thereby identifying the proper mesh table 60 and road link ID 92 (FIG. 5). Step 152 then proceeds to step 154. At step 154, the processor optionally acquires or receives the current weather identifier for the road link identified at step 152 from radio broadcasting if available. Exemplary weather codes are illustrated in FIG. 9. Step 154 then proceeds to step 156.

Step 156 determines the area code and optionally determines other codes which may affect driving conditions. Examples of such optional codes are illustrated in FIG. 10 as a season code, driver code and/or construction code. For example, different drivers may be identified by RFID tag on the vehicle key fob, user input via touch screen or keyboard, physiological input, such as a fingerprint reader, etc. Step 156 then proceeds to step 158.

At step 158 the processor 22 searches the statistical database 42 for entries in the statistical database 42 corresponding to the road link identified at step 152, current conditions identified at step 154 and the optional codes identified at step 156. Step 158 then proceeds to step 160.

At step 160, the processor 22 calculates the fraction of the statistical time from the statistical database 42/the real-time travel time of the vehicle on the road link and assigns the fraction to a variable RATE. Step 160 then proceeds to step 162.

In some cases a nonrepeatable incident, such as an automotive accident, has occurred on the road link so that the real-time data of the vehicle travel along that road link constitutes statistically bad data and should be disregarded. For that reason, step 162 compares the fraction RATE determined at step 160 with the predetermined minimum and maximum thresholds Th_min and Th_max. For example, Th_min may be set to a number such as 0.8 while Th_max may be set to a number such as 1.2. In the event that the fraction rate falls outside the range Th_min-Th_max, indicative of statistically invalid data, step 162 branches to step 164 where the algorithm is terminated.

Otherwise, i.e. if the fraction rate falls within the range Th_min-Th_max, step 162 instead branches to step 164 where a new statistical link travel time is determined from the average of the statistical time in the database 42 and the real-time travel of the vehicle along that link. After return of the algorithm at step 164, that newly calculated statistical data is used to update the statistical database at step 128 (FIG. 6).

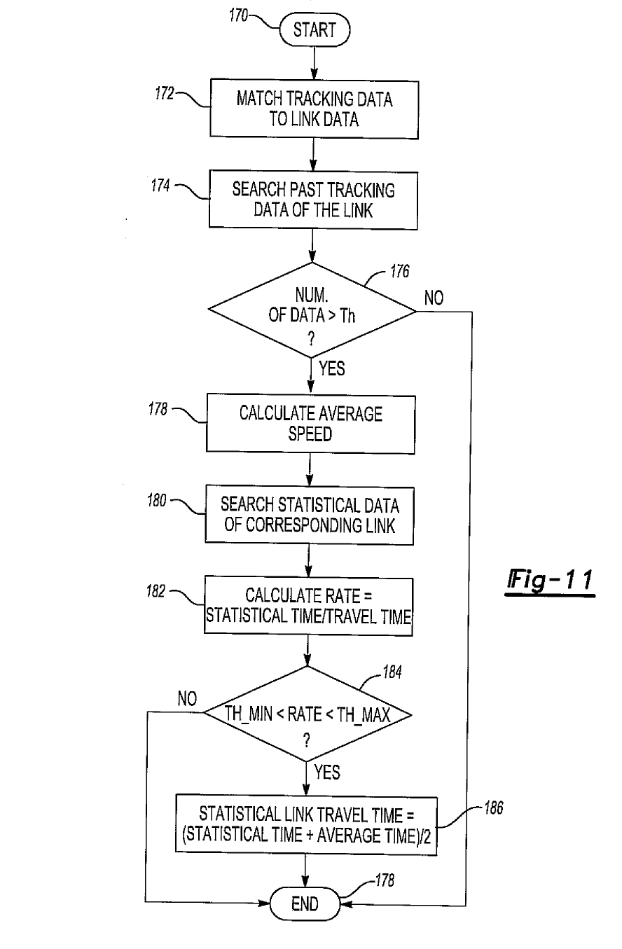

With reference now to FIG. 11, a flowchart illustrating a still further statistical processing of the traffic data is illustrated in which a number of data samples for each road link is accumulated and then averaged prior to updating the statistical database. By averaging a number of data samples for the road link, large variations in the statistical database caused by erratic data are eliminated or at least minimized.

With reference then to FIG. 11, after initiation of the algorithm at step 170, step 170 proceeds to step 172 where the vehicle tracking data is matched to the link data in the link database 46 in the same manner at step 152 in FIG. 8. Step 172 then proceeds to step 174.

At step 174, the processor 22 searches the past tracking data for the particular road link in the vehicle tracking database 44. Step 174 then proceeds to step 176.

At step 176 the processor 22 determines if the number of data samples identified at step 174 exceeds a predetermined number Th. If not, step 176 branches to step 178 where the algorithm is terminated.

For example, assuming that the threshold number of data Th is equal to five, step 176 will branch to step 178 whenever five or less data samples for the particular road link are stored in the vehicle tracking database 44. However, whenever the number of stored data samples in the vehicle tracking database 44 exceeds the threshold Th, step 176 instead branches to step 178.

At step 178, the processor 22 calculates the average speed of the vehicle along the road link using all of the data samples for that road link stored in the vehicle tracking database 44. Step 178 then proceeds to step 180.

At step 180 the processor 22 searches the statistical database 42 for entries in the statistical database 42 corresponding to the road link identified at step 172. Step 180 then proceeds to step 182.

At step 182, the processor 22 calculates the fraction of the statistical time from the statistical database 42/the average real-time travel time of the vehicle on the road link calculated at step 178 and assigns the fraction to a variable RATE. Step 182 then proceeds to step 184.

Step 184 compares the fraction RATE determined at step 182 with the predetermined minimum and maximum thresholds Th_min and Th_max. For example, Th_min may be set to a number such as 0.8 while Th_max may be set to a number such as 1.2, although other ranges may also be used. In the event that the fraction rate falls outside the range Th_min-Th_max, indicative of statistically invalid data, step 184 branches to step 178 where the algorithm is determined.

Otherwise, i.e. if the fraction rate falls within the range Th_min-Th_max, step 184 instead branches to step 186 where a new statistical link travel time is determined from the average of the statistical time in the database 42 and the average real-time travel of the vehicle along that link over the last Th data samples. After return of the algorithm at step 178, that newly calculated statistical data is used to update the statistical database at step 128 (FIG. 6).

Still other statistical processing of the real time travel data of the vehicle may be performed without deviation from the scope of the present invention.

Although the navigation system, software configuration and database formats have been described in detail, it will be understood that this is by way of example only and that no undue limitations should be drawn therefrom.

From the foregoing, it can be seen that the present invention provides a navigation system and method for not only internally acquiring real-time traffic flow for road links traveled by the vehicle, but for also updating the statistical database in the navigation system internally and without the need to access external servers for such information. Having described our invention, however, many modifications thereto will become apparent to those skilled in the art to which it pertains without deviation from the spirit of the invention as defined by the scope of the appended claims.

We claim:

1. In a navigation system in a vehicle having a statistical database containing travel data for a plurality of road links, each link having two end nodes, a method of updating data contained in the statistical database comprising the steps of:
receiving real-time travel data of the vehicle for at least one of the road links in the statistical database as the vehicle travels betweens the end nodes of said at least one road link,
processing said acquired real-time travel data in the navigation system which meets preset criteria for said at least one road link to produce processed travel data, and
updating the road link data for said at least one road link in the statistical database in the navigation system with said processed travel data.

2. The invention as defined in claim 1 wherein said acquiring step further comprises the steps of acquiring a predetermined number of real-time travel data samples for said at least one road link, and wherein said processing step further comprises the step of calculating an average data of said predetermined number of real-time travel data samples for said at least one road link, said average data forming said processed travel data.

3. The invention as defined in claim 1 wherein said processing step further comprises the step of comparing the acquired real-time travel data for said at least one road link with corresponding road link data in the statistical database and disregarding said acquired real-lime travel data whenever said acquired real-time travel data differs from said corresponding road link data in the statistical database by more than a predetermined amount.

4. The invention as defined in claim 1 wherein said statistical database associates a condition code with each road link and comprising the step of acquiring a current condition code and wherein said processing step further comprises the step of processing said acquired real-time travel data in the navigation system which meets preset criteria for said at least one road link and also the same condition code to produce processed travel data.

5. The invention as defined in claim 4 wherein said condition code correlates to a weather condition.

6. The invention as defined in claim 4 wherein said step of acquiring the current weather code comprises the step of acquiring said weather code by radio transmission.

7. The invention as defined in claim 1 wherein said processing step further comprises the steps of determining a geographic area for the motor vehicle and searching for said at least one road link only in said geographic area.

8. The invention as defined in claim 1 wherein said updating step comprises the steps of calculating an average travel data of said processed travel data for said at least one road link and the corresponding road link data in the statistical database, and thereafter storing said average travel data in said statistical database.

9. The invention as defined in claim 1 wherein said statistical database associates a driver code with each road link and comprising the step of acquiring a current driver code and wherein said processing step her comprises the step of processing said acquired real-time travel data in the navigation system which meets preset criteria for said at least one road link and also the same driver code to produce processed travel data.

10. In a navigation system in a vehicle having a statistical database containing travel information for a plurality of road links, each link having two end nodes, a system for updating data contained in the statistical database comprising:
means for receiving real-time travel data of the vehicle for at least one of the road links in the statistical database as the vehicle travels betweens the end nodes of said at least one road link,
means for processing said acquired real-time travel data in the navigation system which meets preset criteria for said at least one road link to produce processed travel data, and
means for updating the road link data for said at least one road link in the statistical database in the navigation system with said processed travel data.

11. The invention as defined in claim 10 wherein said means for acquiring further comprises means for acquiring a predetermined number of real-time travel data samples for said at least one road link, and wherein said means for processing further comprises means for calculating an average data of said predetermined number of real-time travel data samples for said at least one road link, said average data forming said processed travel data.

12. The invention as defined in claim 10 wherein said means for processing further comprises means for comparing the acquired real-time travel data for said at least one road link with corresponding road link data in the statistical database and means for disregarding said acquired real-time travel data whenever said acquired real-time travel data differs from said corresponding road link data in the statistical database by more than a predetermined threshold.

13. The invention as defined in claim 10 wherein said statistical database associates a condition code with each road link and comprising means for acquiring a current condition code and wherein said means for processing further comprises means for processing said acquired real-time travel data in the navigation system which meets preset criteria for said at least one road link and also the same condition code to produce processed travel data.

14. The invention as defined in claim 13 wherein said condition code correlates to a weather condition.

15. The invention as defined in claim 13 wherein said means for acquiring the current weather code comprises means for acquiring said weather code by radio transmission.

16. The invention as defined in claim 10 wherein said means for processing further comprises means for determining a geographic area for the motor vehicle and means for searching for said at least one road link only in said geographic area.

17. The invention as defined in claim 10 wherein said means for updating comprises means for calculating an average travel data of said processed travel data for said at least one road link and the corresponding road link data in the statistical database, and means for storing said average travel data in said statistical database.

18. The invention as defined in claim 10 wherein said statistical database associates a driver code with each road link and comprising means for acquiring a current driver code and wherein said means for processing further comprises means for processing said acquired real-time travel data in the navigation system which meets preset criteria for said at least one road link and also the same driver code to produce processed travel data.

19. In a navigation apparatus in a vehicle having a statistical database containing travel information for a plurality of road links, each link having two end nodes, a system for updating data contained in the statistical database comprising:
a receiver for real-time travel data of the vehicle for at least one of the road links in the statistical database as the vehicle travels betweens the end nodes of said at least one road link,
a processor of said acquired real-time travel data in the navigation system which meets preset criteria for said at least one road link to produce processed travel data, and
an updater for the road link data for said at least one road link in the statistical database in the navigation system with said processed travel data.

20. The invention as defined in claim 19 wherein said receiver further comprises an amasser of a predetermined number of real-time travel data samples for said at least one road link, and wherein said processor further comprises a calculator of an average data of said predetermined number of real-time travel data samples for said at least one road link, said average data forming said processed travel data.

21. The invention as defined in claim 19 wherein said processor further comprises a comparator of the acquired real-time travel data for said at least one road link with corresponding road link data in the statistical database which disregards said acquired real-time travel data whenever said acquired real-time travel data differs from said corresponding road link data in the statistical database by more than a predetermined threshold.
